(19) United States
(12) Patent Application Publication
(10) Pub. No.: US 2002/0058729 A1
(43) Pub. Date: May 16, 2002

(54) Electrostatic ink jet ink and method of controlling electrostatic charges of color material in the ink

(76) Inventor: Kenji Oshima, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 09/935,661

(22) Filed: Aug. 24, 2001

(30) Foreign Application Priority Data
Aug. 24, 2000 (JP) 2000-253745

(51) Int. Cl. C09D 11/00

(52) U.S. Cl. 523/160

(57) ABSTRACT

An ink for ink jet printer comprising: a highly electrically insulating dispersant mainly comprising an aliphatic hydrocarbon solvent; a color material insoluble in the dispersant; a polymer having at least repeating units represented by the following general formula (1) and soluble in the dispersant, and a metal soap. The ink enables high-speed stable printing of high-density dots substantially free from ink bleeding. Moreover, the present invention provides a method of effectively controlling electrostatic charges of the color material in the ink.

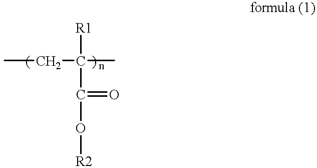

wherein R1 is one of a hydrogen atom and a methyl group, and R2 is an alkyl group having 4 to 22 carbon atoms.

### FIELD OF THE INVENTION

The present invention relates to an ink for use with an electrostatic ink jet printer and the like, and particularly to an ink for electrostatic ink jet and a method of controlling electrostatic charges of color material in the ink.

### BACKGROUND OF THE INVENTION

The ink jet recording method, in which characters are printed by ejection ink onto a recording medium and forming recording dots thereon, is drawing attention as a non-impact recording method that facilitates color printing and is capable of direct recording onto plain paper. Various kinds of printers employing this method are putting into practical use.

One of ink jet recording methods is an electrostatic ink jet recording method. In this method, electric fields are applied between a plurality of recording electrodes opposed to a recording medium and a counter electrode disposed at the back of the recording medium. The potential difference between the electrodes exerts electrostatic force to the ink supplied on the recording electrodes and ejects the ink onto the recording medium.

Such an ink jet printer is described in a book “Ink Jet Recording Technology” (Triceps Co. Ltd., 1989), for example. An example of a drop-on-demand type full-color recording head structured in accordance with such an electrostatic ink jet system is disclosed in Japanese Patent Laid-Open Non-examined Publication No. S58-215253 and in J. Inst. of Electronics and Communication Engineers (IECE), Vol. J68-C, 2, pp.93-100 (1985).

This system employs a slit-like ink ejection port having a plurality of recording electrodes on the inner wall thereof instead of a nozzle provided in a conventional ink jet head (hereinafter referred to as a “head”). The ink ejection port of this system is rarely clogged with ink and the head has a simple structure. Thus reduction in manufacturing cost of the head can be expected. Moreover, this head structure is effective in producing a so-called “long line head” that can print a wide range in the direction of the width of the recording medium.

Preferably used in an example of this electrostatic head is an oil base ink containing a dye dissolved in an organic solvent. As for the ingredients of the ink, an example shown in J.IECE,Vol.J68-C,2, pp.93-100 (1985) uses an ink having such physical property as, a volume resistivity of 10⁷ to 10⁸ Ωcm, surface tension of 22 mN/m, and a viscosity of 3.1 to 6.9 cP.

However, such an oil base ink has extremely large permeability to recording paper because it has a surface tension lower than that of water inks commonly used for other ink jet systems. Therefore, the oil base ink poses problems such as low printing density, ink bleeding and setoff when printed onto ordinary paper.

On the other hand, in Japanese Patent Laid-Open Non-examined Publications Nos. H09-11475, H09-118015 and H09-193389 and the like, other examples of an ink containing electrostatically charged color particles dispersed in a highly electrically insulating liquid are disclosed. Disclosed in these publications are electrostatic heads that concentrate color particles on the ejection port by electrophoresis and eject ink droplets containing highly concentrated color material.

With the examples shown in these publications, the detailed discharging principle thereof is not clarified. However, the ingredients of the ink are not ejected uniformly with a large quantity of liquid components contained therein, unlike the example shown in the Journal. Instead, the color material of the ink is coagulated and ejected substantially with less liquid components contained therein. This is to address the above-mentioned problems. In addition, the use of pigment as a color material can bring more advantageous results than the head using an ink containing a conventional dye, in terms of water resistance and light resistance of printed images.

In order to obtain excellent printing characteristics with high printing density and without any ink bleeding or setoff using such a color material coagulated type ink for electrostatic ink jet, firstly, it is necessary that the volume resistivity of the liquid components constituting the ink sufficiently be high enough. This enables the electric field applied by the recording electrodes and counter electrode to reach to the color particles. When the volume resistivity of the liquid components is low, the ink is charged up by carrier injection via voltage applied by the recording electrodes. As a result, the ink is prone to be ejected with a large quantity of liquid components contained therein by electrostatic repulsion.

Secondly, the color particles must have a sufficient amount of electrostatic charges, that is, the particles must have [symbol] potential with highly positive or negative polarity. This is because color particles must be concentrated on the eject port at a sufficient speed by electrophoresis. Furthermore, for excellent ejection performance and prevention of deposition of the color particles, it is preferable that the average particle size of the color particles should be approx. 0.1 to 4 μm.

Specifically, in Japanese Patent Laid-Open Non-examined Publication No. H09-193389 and others, the use of an ink having an electric resistivity of 10⁸ Ωcm or higher, most preferably 10¹⁰ Ωcm or higher is disclosed. The ink contains, in a dielectric liquid having an electric resistivity of 10¹⁰ Ωcm or higher, dispersed developer particles (solid resin particles containing at least colorant components) having a [symbol] potential of 60 mV or higher relative to the dielectric liquid and an average particle size of 0.01 to 5 μm. Such an ink uses, as insulating liquid, a hydrocarbon solvent having a volume resistivity of 10¹⁰ Ωcm or higher, for example. The color material used in the ink includes carbon black, organic pigment, pigment dispersed in a binder comprising resin, wax, and the like, or on the surface thereof. The ink also includes a dispersant, electrostatic charge control agent, and other additives; however, the composition of the ink, the methods for preparing the ink and for controlling the physical properties of the ink are not disclosed in detail.

With an increasing demand for a printer having higher printing speed and higher-quality images, the above-mentioned color material coagulating head requires a technique for printing high-definition images at high speeds by stable and fast ejection of small amount of ink droplets containing highly condensed color material.

It has been proved that printing performance depends largely on the physical properties of the ink. Therefore, in order to obtain sufficient printing performance, as mentioned in the explanation of the prior art, it is preferable that ink impart high [symbol] potential to its color material while maintaining a high volume resistivity of 10¹⁰ Ωcm or higher. A low [symbol] potential of the color material cannot move the color material to the ejection port, i.e. the tip end of the ejection electrodes at high speeds by electrophoresis. As a result, the color material will be supplied to the tip end insufficiently in poorly coagulated condition and thus the ejection response frequency becomes low.

When the electrostatic repulsion between the surfaces of the ejection electrodes and the color material is weak, the color material adheres to and accumulates on the electrodes and stable ejection may be disturbed. For such a reason, there are problems that sufficient printing density cannot be obtained and stable and high-speed printing cannot be performed.

To address these problems, a metal soap, ionic compound, or surface active agent soluble in the dispersant must be added as an electrostatic charge control agent and make the color material in the ink sufficiently charged. However, it is difficult to impart sufficiently high [symbol] potential to the color material and control the [symbol] potential while satisfying the requirements for the physical properties of the ink, such as volume resistivity. Effective methods have not been disclosed.

In order to address these problems, the inventors have studied how to control electrostatic charges of the color material in the ink by using a polymer and metal soap, and reached to the present invention.

It is an object of the present invention to provide a color material coagulated type ink for an electrostatic head that enables stable and high-speed printing of high-density dots substantially free from ink bleeding. It is also an object of the present invention to provide a method of effectively controlling the electrostatic charges of the color material in the ink.

### SUMMARY OF THE INVENTION

An ink in accordance with the present invention includes:

a highly electrically insulating dispersant based on an aliphatic hydrocarbon solvent;

a color material insoluble in the dispersant;

a polymer including at least repeating units represented by the following general formula (1) and soluble in the dispersant; and

a metal soap.

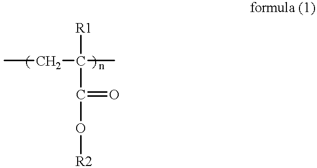

where R1 is a hydrogen atom or methyl group and R2 is an alkyl group having 4 to 22 carbon atoms.

### BRIEF DESCRIPTION OF THE DRAWINGS

FIG. 1 is a perspective view illustrating a structure of an electrostatic head used for evaluation of inks in accordance with an embodiment of the present invention.

### DETAILED DESCRIPTION OF THE INVENTION

An ink in accordance with the present invention is characterized in including:

a highly electrically insulating dispersant based on an aliphatic hydrocarbon solvent;

a color material insoluble in the dispersant;

a polymer having repeating units represented by the following general formula (1) and soluble in the dispersant;

and a metal soap.

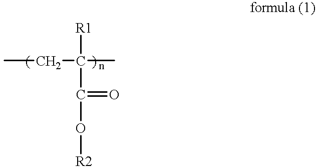

where R1 is a hydrogen atom or methyl group and R2 is an alkyl group having 4 to 22 carbon atoms.

Moreover, the ink in accordance with the present invention has 6 to 12 carbon atoms in the fatty acid molecule constituting the above-mentioned metal soap. When the number of the carbon atoms is 6 to 12, the metal soap has sufficient solubility in the dispersant.

Furthermore, the ink in accordance with the present invention is characterized in that the carbon number of fatty acids constituting the metal soap is 6-12. With a carbon number of fatty acids being 6-12, the metal soap has good solubility against the dispersant.

Further, fatty acids constituting the metal soap is one of naphthenic acid, octylic acid and a mixture thereof. These fatty acids have excellent solubility in the dispersant and impart [symbol] potential having highly positive polarity to the color material.

It is preferable that the ink in accordance with the present invention contain a dispersant having a volume resistivity of 10¹³ Ωcm or higher at a temperature of 25° C. It is especially preferable that the dispersant should be a hydrocarbon having a boiling point ranging from 150 to 350° C. Such a dispersant keeps the volume resistivity of the ink at a sufficiently high value, the evaporation rate of the ink at room temperature within an appropriate range, enhances the stability and safety thereof, and inhibits the odor thereof.

The ink in accordance with the present invention has a volume resistivity of 10¹⁰ Ωcm or higher at a temperature of 25° C. and contains a color material having a [symbol] potential of 90 mV or higher. When the volume resistivity is within the above-mentioned range, the color material can be supplied to the tip end of ejection electrodes at a speed sufficient to enhance the ability to eject the coagulated color material. In addition, the use of such ink can prevent the color material from adhering to and accumulating on the ejection electrodes.

The ink in accordance with the present invention can improve the dispersing ability of the color material in the ink and fixing ability of the color material onto a recording medium.

An embodiment of the present invention is described below.

An ink for electrostatic ink jet in accordance with the present invention comprises:

a highly electrically insulating dispersant based on an aliphatic hydrocarbon solvent;

a color material insoluble in the dispersant;

a polymer having repeating units represented by the following general formula (1) and soluble in the dispersant; and

a metal soap.

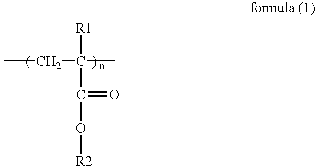

where R1 is a hydrogen atom or methyl group and R2 is an alkyl group having 4 to 22 carbon atoms.

First, ingredients of the ink are described.

It is preferable that the dispersant in accordance with the present invention include aliphatic hydrocarbon solvents as a main component because the dispersant needs to be highly electrically insulative and have a low dielectric constant.

The following is the properties required for the dispersant. Firstly, the volume resistivity of the ink needs to be 10⁹ Ωcm, more preferably 10¹⁰ Ωcm or higher, after a color material, polymer, metal soap and other components are mixed. For this purpose, it is preferable that the dispersant have a volume resistivity of 10¹³ Ωcm or higher. It is also preferable that the dielectric constant of the dispersant being 3.0 or lower.

Secondly, the dispersant is required to minimize its evaporation at the ink eject port and to quickly dry and to fix the ink after printing. For this purpose, the dispersant must have an evaporation rate within an appropriate range at room temperature. Moreover, in order not to ignite, the dispersant must have a flash point of room temperature or higher and show high levels of safety against environment and human body.

The ink dispersant mainly comprising aliphatic hydrocarbon solvents in accordance with the present invention is not limited on condition that it satisfies the above requirements. Preferable aliphatic hydrocarbon solvents include hydrocarbon solvents having boiling points ranging from 150 to 350° C. Commercially available products are Exxon Chemical Japan's ISOPER G, H, L, M and V and NORPER 12, 13 and 15, Idemitsu Petrochemical's IP Solvent 1620 and 2028, Nippon Petrochemical's ISOSOL 300 and 400, and Maruzen Petrochemical's MARCASOL R. These products are aliphatic saturated hydrocarbons of extremely high purity and have a boiling point of 40° C. or higher in addition to a viscosity of 3 cSt or lower, a surface tension of 22.5 to 28.0 mN/m and a resistivity of 10¹³ Ωcm or higher at a temperature of 25° C. Moreover, these products have low reactivity and high stability, low toxicity, and little order, thus exhibiting safety against human body.

In the present invention, such an aliphatic hydrocarbon solvent can be used solely or in combination, as a dispersant. Moreover, a mixture with a solvent other than hydrocarbon compounds compatible with the aliphatic hydrocarbon solvent, such as silicon oils, can be used as long as the mixture satisfies aforementioned requirements and does not affect the solubility of the polymer and metal soap in accordance with the present invention as described later. Examples of such silicon oils include synthesized dimethyl polysiloxane having low viscosity. Commercially available products include Shin-Etsu Silicones' KF 96L and Toray Dow Corning Silicone's SH 200. Although dimethyl polysiloxane having a wide range of viscosity are available depending on their molecular weight, those having a viscosity ranging from 1 to 20 cSt are preferable for satisfying the above-mentioned requirements. Like hydrocarbon solvents, these dimethyl polysiloxane products have a flash point of 40° C. or higher and a volume resistivity of 10¹³ Ωcm or higher, high levels of stability and safety, and no odor.

As color materials, pigments, pigments dispersed in a resin insoluble to the dispersant or pigments having graft polymers on the surface thereof can be used.

Various inorganic and organic pigments can be used. Such pigments include carbon black, β-naphtol-based azo pigment, pyrazolone-based azo pigment, acetoacetic allyllide-based azo pigment, condensed azo pigment, disazo pigment, anthrapridine pigment, indanthrene pigment, phthalocyanine pigment, quinacridone pigment, indigo pigment, isoindolinone pigment, dioxadine pigment, perylene pigment, phtaloperinone pigment, quinophthalone pigment, and titanium dioxide.

As resins insoluble to the dispersant, a variety of known natural or synthesized resins can be used. Such resins include acrylic resin, epoxy resin, ethylene-vinyl acetate resin, vinyl chloride-vinyl acetate resin, and styrene-butadiene resin. As methods of dispersing pigment in these resins, various known methods as shown in the process of manufacturing electrophotographic toner particles can be used. Processed pigments containing pigment particles dispersed in rosin ester resin or vinyl chloride-vinyl acetate resin are commercially available and such products can be used.

In the ink in accordance with the present invention, preferably, the concentration of the color material relative to the total amount of the ink is 0.5 to 15 wt %, and more preferably, 2 to 10 wt %. When the concentration of the color material is lower than 0.5 wt %, sufficient printing density cannot be obtained. When the concentration of the color material is higher than 15 wt %, the viscosity of the ink increases and stable ink ejection cannot be performed. These cases are not preferable.

Mainly for dispersing the above-mentioned color material and improving the dispersing ability thereof in the dispersant, a resin soluble or partly soluble in the dispersant can be added. In other words, the above-mentioned resin serves as a dispersant and a binder and also serves to improve fixing ability of the color material onto the recording medium.

In terms of the effect of the dispersant, a resin having a high affinity with the color material is preferable. In terms of the effect of the binder, a solid resin or liquid resin with high viscosity at room temperature is preferable. Any kind of resin can be used as long as it satisfies such requirements. Such preferable resins include hydrocarbon resin, alkyd resin, and acrylic resin.

With the ink in accordance with the present invention, preferably, the concentration of the resin relative to the total amount of the ink is 0.1 to 20 wt %, and more preferably, 1 to 15 wt %. When the concentration of the resin is lower than 0.1 wt %, the effect of improving dispersing ability of the color material, or the effect of improving fixing ability of the color material onto the recording medium are substantially lost. When the concentration of the resin is higher than 20 wt %, the viscosity of the ink increases and stable ink ejection cannot be performed. These cases are not preferable.

As described later, when a polymer having a good affinity with the color material and a sufficient molecular weight is used as a polymer constituting the ink in accordance with the present invention, the above-mentioned dispersing function and binder function can be obtained, as well as a function to control electrostatic charge of the color material, which is an object of the present invention. In that case, the above-mentioned resin needs not be added necessarily.

As a polymer soluble in the dispersant and having at least repeating units represented by the above-mentioned general formula (1), which is a first feature of the ink composition in accordance with the present invention, homopolymers, random copolymers, block copolymers and graft copolymers having alkyl ester in their side chains can be used.

In terms of affinity with the dispersant mainly comprising an aliphatic hydrocarbon solvent, a polymer having 4 to 22 carbon atoms in R2 of general formula (1) is preferable.

Examples of monomers for forming such repeating units include isobutyl methacrylate, hexyl acrylate, hexyl methacrylate, octyl acrylate, octyl methacrylate, 2-ethyl hexyl acrylate, 2-ethyl hexyl methacrylate, decyl acrylate, decyl methacrylate, dodecyl acrylate, dodecyl methacrylate, hexadecyl acrylate, hexadecyl methacrylate, octadecyl acrylate, and octadecyl methacrylate.

Monomers that can be copolymerized with these monomers include: alkenes (e.g. butene, hexane, octene, 2-ethyl hexane, decene, dodecene, hexadecene, octadecene) and their derivatives; alkyl vinyl ether (e.g. alkyl group: methyl, ethyl, butyl, hexyl, octyl, 2-ethyl hexyl, decyl, dodecyl, hexadecyl, and octadecyl) and their derivatives; cycloalkyl vinyl monomers (e.g. vinyl cyclopentane and vinyl cyclohexane) and their derivatives; aromatic vinyl monomers (e.g. styrene, 2-methyl styrene, 3-methyl styrene, 4-methyl styrene, 4-ethyl styrene, 4-propyl styrene, 4-butyl styrene, 4-t-butyl styrene, 4-hexyl styrene, 4-octyl styrene, 4-cyclohexyl styrene, 1-vinyl naphthalene, and 2-vinyl naphthalene) and their derivatives; acrylate monomers (e.g. methyl acrylate, ethyl acrylate, propyl acrylate, dimethyl amino ethyl acrylate, diethyl amino ethyl acrylate, and tetraoxy ethyl acrylate) and their derivatives; methacrylate monomers (e.g. methyl methacrylate, ethyl methacrylate, propyl methacrylate, dimethyl amino ethyl methacrylate, and diethyl amino ethyl methacrylate) and their derivatives; and acrylic acid, methacrylic acid and maleic anhydride.

The number of kinds of monomers constituting the polymer is not specifically limited. Homopolymers or copolymers of the above-mentioned monomers or copolymers made by copolymerization with other monomers capable of copolymerization can be used.

In order for a polymer to be solvated with the dispersant and to obtain an efficient solubility to the dispersant, it is preferable that the combination of monomers and their composition ratio should be such that the polymer has a structure similar to that of the dispersant or the polymer and dispersant have a similar polarity. In other words, it is preferable that the monomers include relatively long hydrocarbon chains so that the polarity of the polymer is low.

Preferable examples of copolymers that satisfy above requirements include random polymers, block polymers, and graft polymers such as:

copolymers (e.g. methyl acrylate/octadecyl acrylate, styrene/dodecyl acrylate, styrene/tridecyl acrylate, dodecyl methacrylate/butyl acrylate, octyl methacrylate/butyl acrylate, dodecyl methacrylate/glycidyl methacrylate, 2-ethyl hexyl acrylate/acrylic acid, isodecyl methacrylate/diethyl amino ethyl methacrylate, dodecyl methacrylate/dimethyl amino ethyl methacrylate, dodecyl methacrylate/diethyl amino ethyl methacrylate, dodecyl methacrylate/p-methyl styrene, and dodecyl methacrylate/p-dimethyl amino styrene);

terpolymers (e.g. dodecyl methacrylate/isodecyl methacrylate/methyl methacrylate, octadecyl methacrylate/cyclohexyl acrylate/methacrylic acid, octyl acrylate/crotonic acid/dodecyl methacrylate, glycidyl methacrylate/octadecyl methacrylate/dodecyl methacrylate, dodecyl methacrylate/octyl methacrylate/glycidyl methacrylate, isodecyl methacrylate/octadecyl methacrylate/acrylic acid, p-methyl styrene/tetradecyl methacrylate/isobutyl methacrylate, styrene/octadecyl methacrylate/dimethyl amino methyl methacrylate, styrene/dodecyl acrylate/tridecyl acrylate, p-methyl styrene/isobutyl methacrylate/2-ethyl hexyl acrylate, p-t-butyl styrene/isobutyl methacrylate/2-ehtyl hexyl acrylate, and methyl acrylate/octadecyl acrylate/tetraoxy ethyl acrylate); and

tetrapolymers (e.g. N-vinyl pyrrolidone/butyl acrylate/dodecyl methacrylate/octadecyl methacrylate, and acrylic acid/octadecyl acrylate/methyl methacrylate/isodecyl acrylate).

These (co)polymers can be used in combination with a resin soluble or partly soluble in the dispersant that is added to serve mainly as a dispersing agent or a binder.

The compounds represented by formulae (2) to (15) in the attached sheets are examples of preferable polymers.

Preferably, the metal soap in accordance with the present invention is composed of a metallic salt of a fatty acid having 6 to 12 carbon atoms because it is soluble in the aforementioned highly electrically insulating dispersant mainly comprising an aliphatic hydrocarbon solvent.

Especially, a metal soap containing naphthenic acid or octylic acid as fatty acid components is most preferable because it is highly soluble even in high purity aliphatic hydrocarbon solvents having an extremely low kauri-butanol value (30 or less) and exhibits high electrostatic charging performance.

As metal atoms of these metal soaps, manganese, lead, zinc, calcium, aluminum, zirconium, copper and iron can be used. Examples of preferable metal soaps include manganese naphthenate, iron naphthenate, nickel naphthenate, zirconium naphthenate, manganese octylate, iron octylate, nickel octylate, and zirconium octylate.

The use of these metal soaps and the above-mentioned polymers in combination can impart [symbol] potential having highly positive polarity to the color material.

In accordance with the present invention, it is preferable that the concentration of the metal soap relative to the total amount of the ink should be 0.01 to 2.0 wt %. When the concentration of the metal soap is lower than 0.01 wt %, the effect of imparting high [symbol] potential to the color material is substantially lost. When the concentration of the metal soap is higher than 2.0 wt %, the volume resistivity of the ink decreases and thus the printing density tends to decrease. Generally, a metal soap is supplied with its metal components 5 to 20% depending on the kinds of the metal after being diluted by a solvent or plasticizer. The above-mentioned value in weight percent shows the amount of the metal soap after dilution.

The basic ingredients of the ink in accordance with the present invention are as mentioned above, and a dispersing agent, surface active agent, wax, dye and other additives can be added as required.

Next, the method for preparing the ink is described. In order to prepare the ink, general methods known for preparing various kinds of pigment inks can be used.

An example of preparing method includes the following steps:

weighing a color material, resin, (co)polymer, metal soap, and other supplementary additives so that they have a predetermined compounding ratio;

mixing the above composition with a dispersant so that they are within an appropriate viscosity range;

mixing and milling the mixture for several to several tens of hours using such dispersing machines as a bead mill, attlighter, and ball mill;

obtaining concentrated liquid of the ink in which the color material having a grain size of several hundred nm to several μm is dispersed; and

diluting the concentrated liquid using the dispersant to a predetermined concentration.

Another method includes the steps of:

mixing and milling a color material, resin, and supplementary additives and diluting them in the same manner as described above; and adding a (co)polymer and metal soap.

Still another method includes the steps of:

mixing, milling, and diluting a color material, resin, (co)polymer and supplementary additives in the same manner as described above; and adding a metal soap.

Any of the above method can bring the same effect.

Next, examples of the present invention are described below.

### EXAMPLE 1

Added to 82.3 g of an Exxon Chemical's isoparaffin hydrocarbon, ISOPER G (product name), are 5.0 g of p-methyl styrene/isobutyl metacrylate/2-ethyl hexyl acrylate terpolymer (molar ratio: 56/34/10, weight average molecular weight: 80000, hereinafter referred to as Copolymer “a”) and 2.67 g of manganese naphthenate (metal component: 10%, which percentage is applicable to all the examples shown below). The mixture is stirred at room temperature until the terpolymer and manganese naphthenate were completely dissolved. The stirred mixture and 10.0 g of pigment Reflux Blue R54 (product name of Clariant Japan), which is added as a color material, are put into an agate pot together with zirconia beads and then mixed and milled by a planetary ball mill for 24 hours. A pigment dispersion containing 10 wt % of the color material therein is obtained.

The pigment dispersion is diluted by ISOPER G and ink A having the following composition is prepared.

| | | |
|---|---|---|
| ISOPER G | 94.7 | wt % |
| Reflux Blue R54 | 3.0 | wt % |
| Copolymer “a” | 1.5 | wt % |
| Manganese naphthenate | 0.8 | wt % |

The pigment in ink A shows an extremely high [symbol] potential of 120 mV at a temperature of 25° C. Ink A has a volume resistivity of 10¹⁰ Ωcm or higher.

For the measurement of [symbol] potential, Otsuka Electronics [symbol] electrometer model ELS-6000 is used. The ink diluted to approx. 1,000 times by the dispersant is poured into a measuring cell for low-dielectric constants measurement, kept at a temperature of 25° C. and [symbol] potentials are measured. The volume resistivity is measured using Keithley Instruments' high resistance meter model 6517 and Toyo Vacuum Industry's electrode model 1 for measuring liquid electrical resistance, in a constant temperature oven at a temperature of 25° C. The measuring conditions of these values are the same with the following comparative examples and examples. As for the volume resistivity of the inks in the following comparative examples and examples, the composition and amount of the polymers and metal soaps were adjusted so that the inks have a volume resistivity of 10¹⁰ Ωcm or higher.

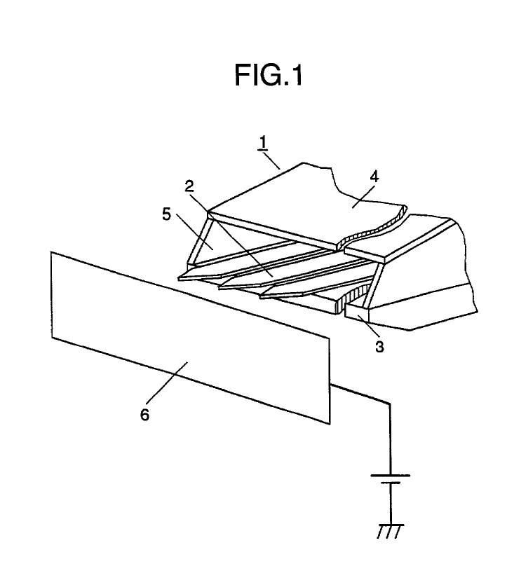

The printing performance of ink A is evaluated using an electrostatic head shown in FIG. 1. FIG. 1 is a perspective view of a structure of an electrostatic head used for evaluation of the ink.

With reference to FIG. 1, head 1 comprises metallic recording electrodes 2 for applying the ink voltage pulses according to recording signals and for ejecting ink droplets, plastic bottom plate 3 having a plurality of recording electrodes 2 formed thereon, plastic top plate 4, and plastic side plates 5. Metallic counter electrode 6 is opposed to recording electrodes 2.

A recording paper (not shown), i.e. a recording medium, is placed between head 1 and counter electrode 6. The recording paper is placed so that it is in contact with counter electrode 6 and movable perpendicularly to the longitudinal direction of head 1.

With reference to FIG. 1, bottom plate 3, top plate 4, and side plates 5 form an elongate slit-like ink ejection port. Ink (not shown) supplied through an ink passage (not shown) that is formed at the back of the head fills this slit-like ink ejection port and forms a meniscus between the tip end of recording electrodes 2 and top plate 4.

In this example, the space between bottom plate 3 and top plate 4, i.e. the slit width, is approx. 150 μm, the width of the recording electrode 2 is approx. 60 μm, the pitch of recording electrodes 2 is approx. 85 μm, and the space between the tip end of recording electrodes 2 and recording paper is approx. 1 mm.

In the head with such a structure, a constant negative voltage is always applied to counter electrode 6 to generate a constant bias electric field toward recording electrodes 2. Applying to recording electrodes 2 positive voltage pulses according to recording signals at a constant frequency while moving a recording paper perpendicularly to the longitudinal direction of head 1 allows electrostatic attractive force to eject ink droplets from the tip end of recording electrodes 2 toward counter electrode 6 and to form printing dots onto the recording paper in a constant cycle.

Using this head and ink A, two millions of dots were printed on copying paper under a following conditions and response to the recording frequency and printing density were evaluated.

counter electrode voltage: −1 kV,

recording electrode voltage: +500V,

recording signal pulse applying time: 200 microseconds, and

recording frequency: 2 kHz

As a result, uniform dots substantially free from ink bleeding were printed without any missing dot at a frequency of 2 kHz in a stable manner. According to visual inspections using an optical microscope, the dots had an optical density of at least 1.4 that was higher than that of a conventional ink jet printer. Table 1 shows a ink compositions and evaluation results.

In the column of Evaluation, when stable printing having an optical density of at least 1.4 is performed at a recording frequency of 2 kHz and the percentage of missing dots is less than 0.05% that is attainable with commercially available ink jet printers, O is marked. In other cases, i.e. when the ejection response frequency is less than 2 kHz, when the percentage of missing dots is 0.05% or higher, or when continuous stable printing cannot be performed, X is marked.

Evaluations are made for the following examples and comparative examples in the same manner.

In the above explanation, the copolymer has a weight average molecular weight of 80000.

But, it should be noted that the feature of the present invention occurs in the combination of (co)polymers having a specific chemical structure and metal soaps. In other words, the molecular weight [i.e. number (n in formula (1)) of the repeating units] of the (co)polymer does not have a significant meaning and is not limited to a specific value. For example, (co)polymers having a weight average molecular weight ranging from 500 to 1,000,000, which values are the most commonly obtained by, for example, radical polymerization or a like polymerization method, can be used in the present invention.

### EXAMPLE 2

Using zirconium octylate (metal component: 12%, which percentage is applicable to all the examples shown below) instead of manganese naphthenate of Example 1, ink B having the following composition is prepared in a manner similar to Example 1.

| | | |
|---|---|---|
| ISOPER G | 95.2 | wt % |
| Reflux Blue R54 | 3.0 | wt % |
| Copolymer “a” | 1.5 | wt % |
| Zirconium octylate | 0.8 | wt % |

As to ink B, the [symbol] potential of the pigment was measured and the printing performance was evaluated in a manner similar to Example 1. The composition, [symbol] potential and printing evaluation of ink B are shown in Table 1. As seen from Table 1, ink B exhibits an extremely high [symbol] potential and has excellent printing results like Example 1.

### COMPARATIVE EXAMPLE 1

Ink C is prepared in a manner similar to Example 1 except that ink C does not contain Copolymer “a”. The [symbol] potential of the pigment was measured and the printing performance was evaluated in a manner similar to Example 1. The composition, [symbol] potential and printing evaluation of ink C are shown in Table 1. As seen from Table 1, ink C exhibits a substantially lower [symbol] potential of the pigment and has poorer printing results than Example 1 containing Copolymer “a”.

### COMPARATIVE EXAMPLE 2

Ink D is prepared in a manner similar to Example 2 except that ink D does not contain Copolymer “a”. The [symbol] potential of the pigment is measured and the printing performance is evaluated in a manner similar to Example 1. The composition, [symbol] potential and printing evaluation of ink D are shown in Table 1. As seen from Table 1, ink D exhibits a substantially lower [symbol] potential of the pigment and has poorer printing results than Example 2 containing Copolymer “a”.

### Comparative example 3

Ink E was prepared in a manner similar to Examples 1 and 2 except that ink E does not contain a metal soap. The [symbol] potential of the pigment is measured and the printing performance is evaluated in a manner similar to Example 1. The composition, [symbol] potential and printing evaluation of ink E are shown in Table 1. As seen from Table 1, ink E exhibits a substantially lower [symbol] potential of the pigment and has poorer printing results than Example 1 and 2 containing a metal soap.

### EXAMPLE 3

Using dodecyl metacrylate/diethyl amino ethyl metacrylate copolymer (molar ratio: 90/10, weight average molecular weight: 10,000, hereinafter referred to as Copolymer “b”) instead of Copolymer “a” of Example 1, ink F having the following composition is prepared in a manner similar to Example 1.

| | | |
|---|---|---|
| ISOPER G | 95.0 | wt % |
| Reflux Blue R54 | 3.0 | wt % |
| Copolymer “a” | 1.2 | wt % |
| Manganese naphthenate | 0.8 | wt % |

As to ink F, the [symbol] potential of the pigment is measured and the printing performance is evaluated in a manner similar to Example 1. The composition, [symbol] potential and printing evaluation of ink F are shown in Table 1. As seen from Table 1, ink F exhibits an extremely high [symbol] potential and has excellent printing results.

### EXAMPLE 4

Using zirconium octylate instead of manganese naphthenate of Example 3, ink G having the following composition is prepared in a manner similar to Example 1.

| | | |
|---|---|---|
| ISOPER G | 95.5 | wt % |
| Reflux Blue R54 | 3.0 | wt % |
| Copolymer “b” | 1.2 | wt % |
| Zirconium octylate | 0.3 | wt % |

As to ink G, the [symbol] potential of the pigment is measured and the printing performance is evaluated in a manner similar to Example 1. The composition, [symbol] potential and printing evaluation of ink G are shown in Table 1. As seen from Table 1, ink G exhibits an extremely high [symbol] potential and has excellent printing results like Example 3.

### COMPARATIVE EXAMPLE 5

Ink H is prepared in a manner similar to Examples 3 and 4 except that ink H did not contain a metal soap. The [symbol] potential of the pigment is measured and the printing performance was evaluated in a manner similar to Example 1. The composition, [symbol] potential and printing evaluation of ink H are shown in Table 1. As seen from Table 1, ink H exhibits a substantially lower [symbol] potential of the pigment and has poorer printing results than Example 3 and 4.

### COMPARATIVE EXAMPLE 6

Ink I is prepared in a manner similar to Example 1 except that ink I contained an alkyd resin (weight average molecular weight: 3,000) as a polymer having no repeating units represented by the general formula (1) instead of Copolymer “a”. The [symbol] potential of the pigment is measured and the printing performance is evaluated in a manner similar to Example 1. The composition, [symbol] potential and printing evaluation of ink I are shown in Table 1. As seen from Table 1, ink I exhibits a substantially lower [symbol] potential of the pigment and has poorer printing results than Example 1.

### COMPARATIVE EXAMPLE 7

Ink J was prepared in a manner similar to Example 1 except that ink J contained an aliphatic hydrocarbon resin (weight average molecular weight: 10,000) as a polymer having no repeating units represented by the general formula (1) instead of Copolymer “a”. The [symbol] potential of the pigment was measured and the printing performance is evaluated in a manner similar to Example 1. The composition, [symbol] potential and printing evaluation of ink J are shown Table 1. As seen from Table 1, ink J exhibits a substantially lower [symbol] potential of the pigment and has poorer printing results than Example 1.

### EXAMPLE 5

Added to 78.3 g iso-paraffin hydrocarbon, MARCASOL R (product name of Maruzen Petrochemical), are 10.0 g of Copolymer “a” and 1.67 g of manganese naphthenate. The mixture is stirred at room temperature until the copolymer and manganese naphthenate are completely dissolved. The mixed solution, and 10.0 g of carbon black pigment MONARCH 120 (product name of Cabot Speciality Chemicals), as a color material, are put into an agate pot together with zirconia beads and then mixed and milled by a planetary ball mill for 24 hours. A pigment dispersion containing 10 wt % of the color material therein is obtained. This pigment dispersion is diluted by MARCASOL R, and ink K having the following composition is prepared.

| | | |
|---|---|---|
| MARCASOL R | 93.5 | wt % |
| MONARCH 120 | 3.0 | wt % |
| Copolymer “a” | 3.0 | wt % |
| Manganese naphthenate | 0.5 | wt % |

As to ink K, the [symbol] potential of the pigment is measured and the printing performance is evaluated in a manner similar to Example 1. The composition, [symbol] potential and printing evaluation of ink K are shown in Table 1. As shown in Table 1, ink K exhibits an extremely high [symbol] potential and has excellent printing results.

### EXAMPLE 6

Using zirconium octylate instead of manganese naphthenate of Example 5, ink L having the following composition was prepared in a manner similar to Example 5.

| | | |
|---|---|---|
| MARCASOL R | 93.88 | wt % |
| MONARCH 120 | 3.0 | wt % |
| Copolymer “a” | 3.0 | wt % |
| Zirconium octylate | 0.12 | wt % |

As to ink L, the [symbol] potential of the pigment is measured and the printing performance is evaluated in a manner similar to Example 1. The composition, [symbol] potential and printing evaluation of ink L are shown in Table 1. As shown in Table 1, ink L exhibits an extremely high [symbol] potential and has excellent printing results.

### COMPARATIVE EXAMPLE 8

Ink M was prepared in a manner similar to Example 5 except that ink M does not contain Copolymer “a”. The [symbol] potential of the pigment is measured and the printing performance is evaluated in a manner similar to Example 1. The composition, [symbol] potential and printing evaluation of ink M are shown in Table 1. As seen from Table 1, ink M exhibits a substantially lower [symbol] potential of the pigment and has poorer printing results than Example 5.

### COMPARATIVE EXAMPLE 9

Ink N is prepared in a manner similar to Example 6 except that ink N does not contain Copolymer “a”. The [symbol] potential of the pigment is measured and the printing performance is evaluated in a manner similar to Example 1. The composition, [symbol] potential and printing evaluation of ink N are shown in Table 1. As seen from Table 1, ink N exhibits a substantially lower [symbol] potential of the pigment and has poorer printing results than Example 6.

### COMPARATIVE EXAMPLE 10

Ink 0 is prepared in a manner similar to Examples 5 and 6 except that ink 0 does not contain a metal soap. The [symbol] potential of the pigment is measured and the printing performance is evaluated in a manner similar to Example 1. The composition, [symbol] potential and printing evaluation of ink O are shown in Table 1. As seen from Table 1, ink O exhibits a substantially lower [symbol] potential of the pigment and has poorer printing results than Examples 5 and 6.

### EXAMPLE 7

Using the Polymer “b” instead of Polymer “a” of Example 5, ink P having the following composition is prepared in a manner similar to Example 5.

| | | |
|---|---|---|
| MARCASOL R | 95.3 | wt % |
| MONARCH 120 | 3.0 | wt % |
| Copolymer “b” | 1.2 | wt % |
| Manganese naphthenate | 0.5 | wt % |

As to ink P, the [symbol] potential of the pigment is measured and the printing performance is evaluated in a manner similar to Example 1. The composition, [symbol] potential and printing evaluation of ink P are shown in Table 1. As seen from Table 1, ink P exhibits an extremely high [symbol] potential and has excellent printing results.

### EXAMPLE 8

Using zirconium octylate instead of manganese naphthenate of Example 7, ink Q having the following composition is prepared in a manner similar to Example 5.

| | | |
|---|---|---|
| MARCASOL R | 95.68 | wt % |
| MONARCH 120 | 3.0 | wt % |
| Copolymer “b” | 1.2 | wt % |
| Zirconium octylate | 0.12 | wt % |

As to ink Q, the [symbol] potential of the pigment is measured and the printing performance is evaluated in a manner similar to Example 1. The composition, [symbol] potential and printing evaluation of ink Q are shown in Table 1. As seen from Table 1, ink Q exhibits an extremely high [symbol] potential and has excellent printing results like Example 7.

### COMPARATIVE EXAMPLE 11

Ink R is prepared in a manner similar to Examples 7 and 8 except that ink R does not contain a metal soap. The [symbol] potential of the pigment is measured and the printing performance is evaluated in a manner similar to Example 1. The composition, [symbol] potential and printing evaluation of ink R are shown in Table 1. As seen from Table 1, ink R exhibits a substantially lower [symbol] potential of the pigment and has poorer printing results than Examples 7 and 8.

The results of the above-mentioned examples show that an ink containing Copolymer “a” or Copolymer “b” and manganese naphthenate or zirconium octylate exhibits an extremely high [symbol] potential of the pigment of 90 to 130 mV and thus has excellent printing characteristics.

In contrast, as seen from the results of comparative examples, an ink containing Copolymer “a” or Copolymer “b” and neither manganese naphthenate nor zirconium octylate or that containing manganese naphthenate or zirconium octylate and neither Copolymer “a” nor Copolymer “b” exhibits a [symbol] potential of the pigment of 30 mV or lower and thus has poor printing characteristics.

As shown in the above-mentioned examples, the ink in accordance with the present invention contains a metal soap and a polymer having repeating units represented by general formula (1) and soluble in a dispersant. This composition can provide a ink that has a high volume resistivity and has a [symbol] potential with highly positive polarity in its color material, more specifically, an ink that has a volume resistivity of 10¹⁰ Ωcm or higher at a temperature of 25° C. and has a [symbol] potential of 90 mV or higher of color material. This composition can provide a color material coagulated type ink for an electrostatic head that enables high-speed stable printing of high-density dots substantially free from ink bleeding.

Moreover, changing the compositions and contents of the polymers and metal soaps can adjust the [symbol] potential of the pigment. Therefore, electrostatic charges of the color material in the color material coagulated type ink for electrostatic head can effectively be controlled.

In the above-mentioned examples, isoparaffin hydrocarbons are used as dispersant. However, any highly electrically insulating and nonpolar liquid that satisfies the requirements given in the explanation of the dispersant can be used as a dispersant.

As mentioned above, the present invention can provide a color material coagulated type ink for an electrostatic head that enables stable printing of high-density dots substantially free from ink bleeding. Also provided is a method for effectively controlling electrostatic charges of a color material in a color material coagulated type ink for an electrostatic head. The present invention can provide an ink for an electrostatic head and a method for controlling the electrostatic charges of a color material in the ink.

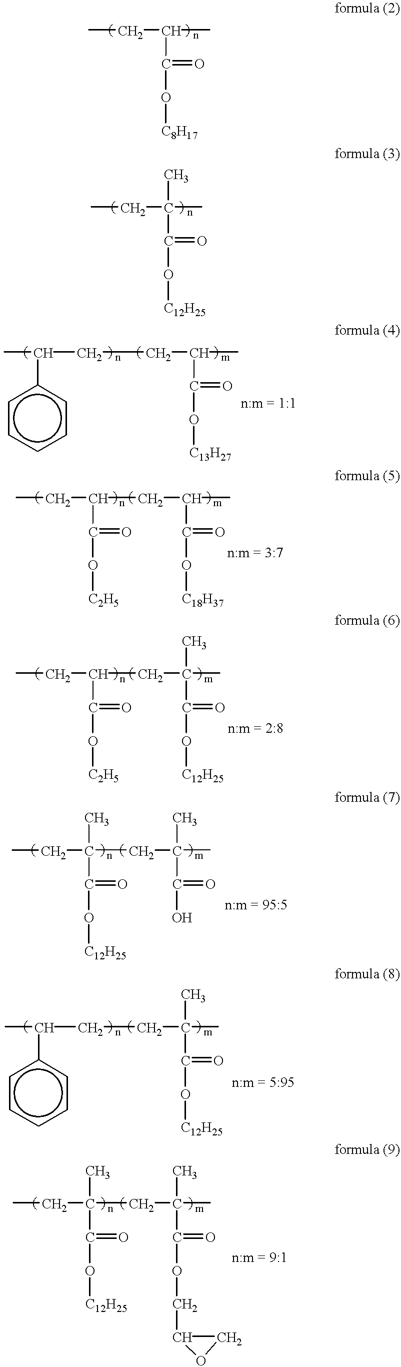

TABLE 1

| | | Ink composition (Wt %) | | | | ξ Potential | |
|---|---|---|---|---|---|---|---|
| | Ink No. | Dispersant | Pigment | Polymer | Metal soap | (mV) | Evaluation |
| Example 1 | A | I-G (94.7) | RB-R54 (3.0) | Copolymer “a” (1.5) | Mn Naph. (0.8) | 120 | ◯ |
| Example 2 | B | I-G (95.2) | RB-R54 (3.0) | Copolymer “a” (1.5) | Zr Oct. (0.3) | 100 | ◯ |
| C-Ex. 1 | C | I-G (96.2) | RB-R54 (3.0) | None | Mn Naph. (0.8) | 30 | X |
| C-Ex. 2 | D | I-G (96.7) | RB-R54 (3.0) | None | Zr Oct. (0.3) | 20 | X |
| C-Ex. 3 | E | I-G (95.5) | RB-R54 (3.0) | Copolymer “a” (1.5) | None | 10 | X |
| Example 3 | F | I-G (95.0) | RB-R54 (3.0) | Copolymer “b” (1.2) | Mn Naph. (0.8) | 130 | ◯ |
| Example 4 | G | I-G (95.5) | RB-R54 (3.0) | Copolymer “b” (1.2) | Zr Oct. (0.3) | 110 | ◯ |
| C-Ex. 5 | H | I-G (95.8) | RB-R54 (3.0) | Copolymer “b” (1.2) | None | 10 | X |
| C-Ex. 6 | I | I-G (94.7) | RB-R54 (3.0) | Alkyd resin (1.5) | Mn Naph. (0.8) | 10 | X |
| C-Ex. 7 | J | I-G (94.7) | RB-R54 (3.0) | Hydrocarbon resin (1.5) | Mn Naph. (0.8) | 30 | X |
| Example 5 | K | M-R (93.5) | M-120 (3.0) | Copolymer “a” (3.0) | Mn Naph. (0.8) | 90 | ◯ |
| Example 6 | L | M-R (93.88) | M-120 (3.0) | Copolymer “a” (3.0) | Zr Oct. (0.12) | 120 | ◯ |
| C-Ex. 8 | M | M-R (96.5) | M-120 (3.0) | None | Mn Naph. (0.5) | 20 | X |
| C-Ex. 9 | N | M-R (96.88) | M-120 (3.0) | None | Zr Oct. (0.12) | 30 | X |
| C-Ex. 10 | O | M-R (94.0) | M-120 (3.0) | Copolymer “a” (3.0) | None | −10 | X |
| Example 7 | P | M-R (95.3) | M-120 (3.0) | Copolymer “b” (1.2) | Mn Naph. (0.5) | 90 | ◯ |
| Example 8 | Q | M-R (95.88) | M-120 (3.0) | Copolymer “b” (1.2) | Zr Oct. (0.12) | 100 | ◯ |
| C-Ex. 11 | R | M-R (95.8) | M-120 (3.0) | Copolymer “b” (1.2) | None | 0 | X |

C-Ex.: Comparative example, I-G: Isoper-G, RB: Reflux blue, M: Monarc, Mn Naph.: Manganese naphthenate, Zr Oct.: Zirconium octylate

What is claimed is:

1. An ink for ink jet printer comprising:
a dispersant mainly comprising an aliphatic hydrocarbon solvent;
a color material insoluble in said dispersant;
a polymer including repeating units represented by the following general formula (1) and soluble in said dispersant; and
a metal soap. 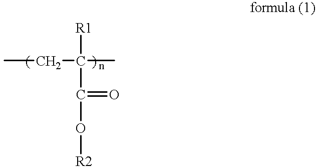
wherein R1 is one of a hydrogen atom and a methyl group, and R2 is an alkyl group having 4 to 22 carbon atoms.

2. The ink as set forth in claim 1 wherein the number of carbon atoms of a fatty acid constituting said metal soap is 6 to 12.

3. The ink as set forth in claim 1 wherein a fatty acid constituting said metal soap is selected from a group consisting of naphthenic acid, octylic acid and a mixture thereof.

4. The ink as set forth in claim 1 wherein said dispersant is a hydrocarbon solvent having a volume resistivity of at least 10¹³ Ωcm and a boiling point ranging from 150 to 350° C.

5. The ink as set forth in claim 1 wherein a volume resistivity of said ink is at least 10¹⁰ Ωcm at a temperature of 25° C. and a [symbol] potential of said color material is at least 90 mV.

6. The ink as set forth in claim 1 wherein said ink is for use with an electrostatic ink jet recording apparatus.

7. A method of controlling electrostatic charge of a color material in an ink for ink jet printer comprising:
adding, to said ink comprising a dispersant mainly comprising an aliphatic hydrocarbon solvent and said color material insoluble in said dispersant, a metal soap and a polymer having repeating units represented by the following general formula (1) and soluble in said dispersant. 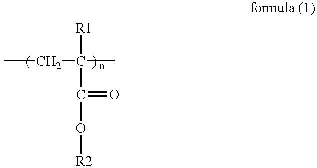
wherein R1 is one of a hydrogen atom and a methyl group, and R2 is an alkyl group having 4 to 22 carbon atoms.
